(19) United States
(12) Patent Application Publication
(10) Pub. No.: US 2005/0047560 A1
(43) Pub. Date: Mar. 3, 2005

(54) Technique for providing personalized interaction for users of an information assistance service

(76) Inventor: Matthew A. Mostad, Kenmore, WA (US)

Correspondence Address: Alex L. Yip;Kaye Scholer LLP, 425 Park Avenue, New York, NY, 10022, US

(21) Appl. No.: 10/654,407

(22) Filed: Sep. 3, 2003

(51) Int. Cl. H04M 1/64; H04M 3/42; H04M 11/00

(52) U.S. Cl. 379/88.19; 379/88.22; 379/88.16

(57) ABSTRACT

An information assistance service center receives a user's call, and the user's profile is examined to identify the user's preferred call handling style. A greeting personalized to the user's preferred call handling style is generated, and delivered to the user. In accordance with an aspect of the invention, the greeting may be dynamic which contains one or more variable parameters representing, e.g., time-sensitive information. One or more items of information pertinent to the variable parameters are obtained and inserted into the dynamic greeting, and the dynamic greeting is delivered to the user.

### FIELD OF THE INVENTION

The invention relates to a communication system and method, and more particularly to a system and method for providing personalized information assistance and communications services.

### BACKGROUND OF THE INVENTION

In this information age, people need to be well informed and organized to effectively carry out day-to-day activities, especially when they are traveling and away from their “home” base where they normally conduct their business. As a result, use of mobile devices which facilitate mobile communications, such as wireless telephones, is ubiquitous.

Wireless phones conveniently allow users while traveling to call and communicate with other people. In case a user cannot remember the telephone number of a contact or it is not handy, or the user wants to obtain directions and other information concerning, e.g., restaurants, theaters, etc., he or she can call an operator for assistance. To that end, an expansive network of communication call centers has been established which provides users with nationwide assistance.

In a typical information assistance service transaction, a user places a call to an information assistance service provider, and is greeted by an operator with a greeting such as “Thank you for using XYZ Company. How may I help you today?” The user typically responds by requesting information, such as, for example, a desired telephone number, driving directions, or a listing of movies that are currently playing. After the operator provides the requested information, the transaction typically ends.

### SUMMARY OF THE INVENTION

In order to enhance the prior art operator assistance service, the service needs to be improved and, more particularly, personalized to ensure that a caller's experience is as “user-friendly” as possible. Some desirable personalized information assistance service features have been described, e.g., in co-pending commonly assigned U.S. patent application Ser. No. 09/865,230 (“the '230 application”) entitled “Technique for Providing Personalized Information and Communications Services,” filed on May 25, 2001, by Nicholas J. Elsey, et al., which is hereby incorporated by reference in its entirety. In particular, the '230 application discloses an information assistance service that maintains one or more user profiles which include information pertaining to and about the user. The user may specify in a profile his/her preferred types of events, areas of interest, food, goods, services, manufacturers, merchants and other personal preferences, e.g., preferred music, fashion, sports, restaurants, seating on a plane, frequent flyer number, frequent stay number, sizes of jackets, etc. Such a profile may be used by a server to tailor the content of information delivered automatically to the user as soon as the information becomes available. The user may also specify in the profile the preferred method of handling his/her information assistance call, e.g., use of a special skilled operator, such as a Spanish speaking operator, to answer such a call. Thus, by using a profile, the user is automatically provided with a personalized service, without the need of otherwise repeating the preferences each time when calling an operator to obtain information and assistance.

Another system for generating and utilizing user profiles is described in commonly assigned U.S. patent application Ser. No. 10/403,130 (“the '130 application”), entitled “Method and System for Providing Customized Interaction for Information Assistance Services Customers,” filed on Mar. 31, 2003, by Timothy A. Timmins, et al., which is hereby incorporated by reference in its entirety.

The present invention improves the above-described information assistance services in multiple ways. For example, in accordance with the invention, a user may specify in the user profile a preferred “call handling style” parameter which an operator may utilize as a basis for interacting with, and providing information to, the user. Thus, in accordance with one aspect of the invention, when an information assistance service center receives a respective user's call, the user's profile is examined to identify the user's preferred call handling style, and a greeting personalized to the user's preferred call handling style is selected. An operator then delivers the selected greeting to the user.

In accordance with another aspect of the invention, a dynamic greeting containing one or more variable parameters, each representing information pertaining to the user's preferred call handling style, is generated. Accordingly, when an information assistance service center receives a respective user's call, the user's profile is examined to identify the user's preferred call handling style, and a dynamic greeting containing one or more variable parameters is selected. One or more items of information pertinent to the variable parameters are obtained, and inserted into the selected dynamic greeting. The selected dynamic greeting is then delivered to the user.

### BRIEF DESCRIPTION OF THE DRAWING

Further objects, features and advantages of the invention will become apparent from the following detailed description taken in conjunction with the accompanying drawing showing an illustrative embodiment of the invention, in which:

FIG. 1 illustrates a communications system including information/call centers in accordance with the invention;

FIGS. 2A and 2B are block diagrams of components of the communications system of FIG. 1;

FIG. 3 illustrates an arrangement whereby an information/call center obtains a user profile record;

FIG. 4 is a flowchart depicting a routine for specifying a user's preferred call handling style;

FIG. 5 illustrates a user profile record in accordance with the invention;

FIG. 6 is a flowchart depicting a routine for generating and delivering a personalized static greeting;

FIG. 7 shows a greetings file containing a plurality of personalized greetings associated with various call handling style preferences;

FIG. 8 illustrates a GUI in accordance with the invention;

FIG. 9 illustrates a user profile record in accordance with the invention;

FIG. 10 is a flowchart depicting a routine for generating and delivering a personalized dynamic greeting;

FIG. 11 illustrates a GUI in accordance with the invention;

FIG. 12 is a flowchart depicting a routine for specifying a preferred greeting; and

FIG. 13 shows a table for tracking a user's ratings for various greetings.

### DETAILED DESCRIPTION

The invention is directed to providing personalized information and communications services to users, e.g., telephone and mobile device users. In particular, the invention provides to a user of an information assistance service personalized interaction based on one or more “call handling style” parameters specified by the user.

To facilitate tailoring the information assistance service to individuals' specifications, one or more user profiles are maintained for a user, based on which the service is rendered to the user. For example, a user profile may specify the preferred method of handling his/her information assistance call, e.g., use of a special skilled operator, such as a Spanish speaking operator, to answer one such call. It may also define options of various assistance service features, e.g., the methods of delivery (e.g., e-mail, paging, SMS, etc.) of a confirmation of a reservation or purchase, a listing number, directions to the user, etc. In addition, in accordance with an aspect of the invention, the user may specify in the user profile a preferred call handling style, such as “skier,” “businessperson,” or “humor.”

For example, a user profile in this instance may be maintained by the inventive information assistance service in association with an identifier of the user, e.g., the user's telephone number. When an information assistance call is received, the subject service locates any profiles of the caller's, e.g., based on an automatic number identification (ANI) associated with the call, or alternatively by, or in combination with, a user identification (ID), password, PIN, mother's maiden name, user voice recognition, user voice print, etc. The ANI in a well known manner identifies the telephone number of the communications device from which the call originates. A technique for generating and utilizing a user profile is described in the '230 application referred to above. Another technique for generating and utilizing user profiles is described in the '130 application, also referred to above.

It should be noted that the preferences in a user profile may vary with time, and may be adjustable depending on different conditions. For example, preferences applicable to the daytime may be turned off in the evening, at which time another set of preferences may control. Similarly, preferences applicable to weekdays may be turned off on weekends in favor of a second set of preferences selected for weekends. Thus, by using the user profile, the user is automatically provided with a personalized service, without the need of otherwise repeating the preferences, e.g., each time when calling an operator to obtain information and assistance. It should be pointed out that the term “operator” used herein broadly encompasses entities that are capable of providing assistance in a telecommunication environment, including without limitation human operators, voice response/recognition capabilities, web-enabled operator services, and other automated and electronic access.

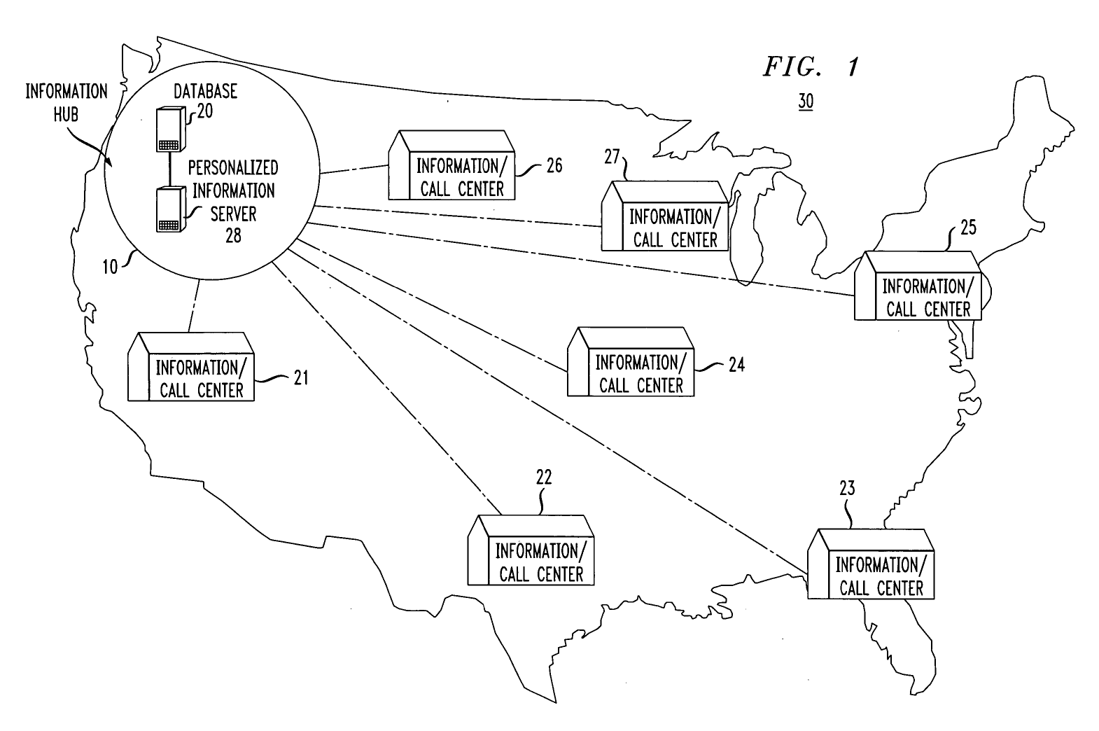

FIG. 1 illustrates a communications system embodying the principles of the invention for providing, inter alia, a personalized information assistance service. This communication system includes wide area network (WAN) 30 covering an extensive area. WAN 30 may be an Internet-based network such as the World Wide Web or a private intranet based network.

WAN 30 connects operators dispersed throughout a wide coverage area in information/call centers 21 through 27. One or more information hubs 10 are also included in WAN 30. An information hub 10 includes one or more personalized information servers 28 which are accessible by the operators in the system, and one or more databases 20 in which subscribers' user profiles may be stored and maintained. Such information may also be stored locally at one or more of the information/call centers.

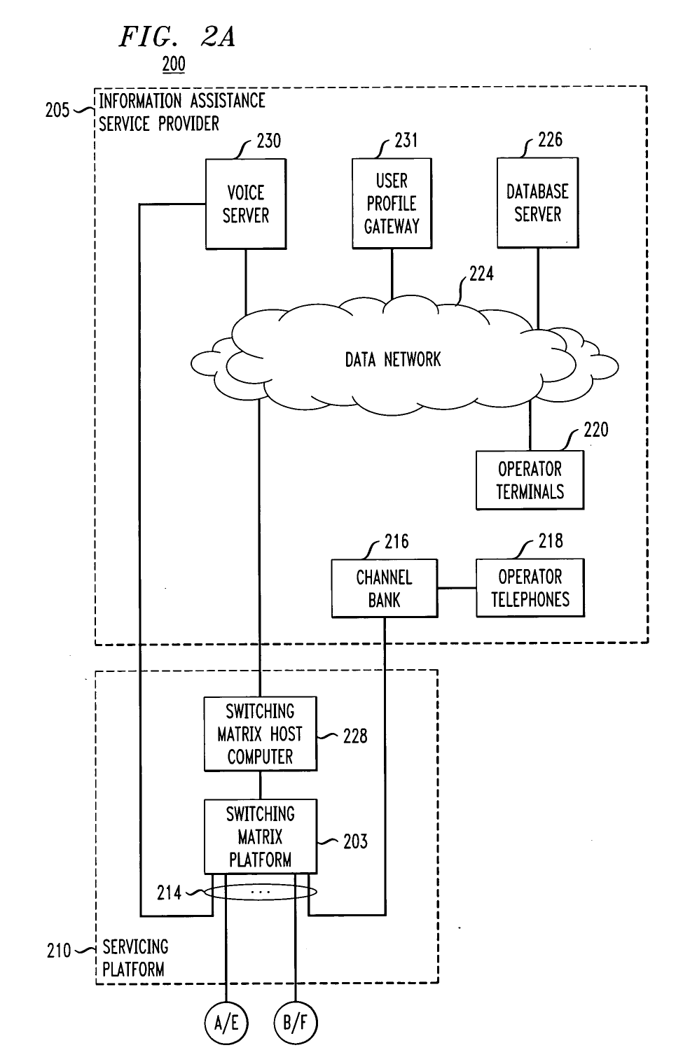

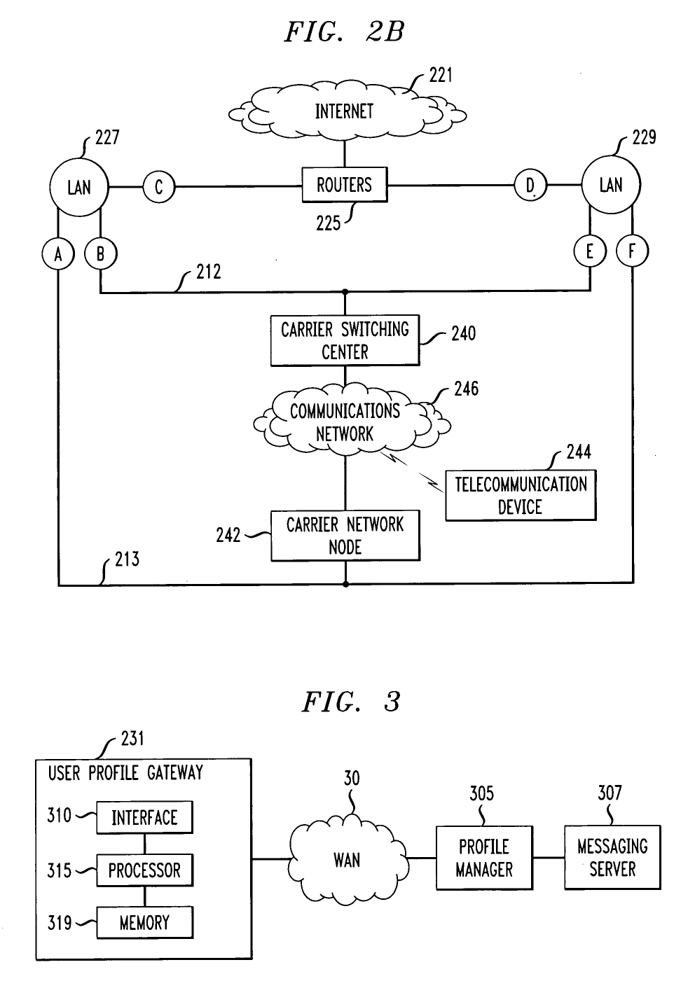

Referring to FIGS. 2A and 2B, information/call center 200 (which generically represents one of aforementioned information/call centers 21 through 27) is attended by operators, which includes information assistance service provider 205 and servicing platform 210. It should be noted that even though both provider 205 and servicing platform 210 appear in the same figure, they may or may not be located in the same geographic area. Servicing platform 210 comprises switching matrix host computer 228, and switching matrix platform 203 which is connected via T1 communication links 214 to, among others, voice server 230 and channel bank 216 in provider 205.

Channel bank 216 is used to couple multiple operator telephones 218 to platform 203. The operators in center 200 are further equipped with operator terminals 220, each of which includes a video display unit and a keyboard with associated dialing pad. Operator terminals 220 are connected over data network 224 to one or more database server(s) 226 (although only one is shown here). Database server 226 provides access to, among others, directory information from multiple sources. Database server 226 enables the operator to search directory information not just by name and address (sometimes city or area code) of a desired party, but also by type of goods/services and/or geographical region of a desired entity.

Data network 224 further connects to voice server 230, user profile gateway 231, and switching matrix host computer 228, which in turn is connected to switching matrix platform 203 via a data link. Data network 224 includes, but is not limited to, local area network (LAN) 227, best seen in FIG. 2B. LAN 227 may connect to other similar remote LANs 229 to form WAN 30 in FIG. 1. LANs 227 and 229 are connected to one another and to Internet 221 via routers 225.

A user's telephone, computer, PDA or other telecommunication device 244 communicates via communications network 246 which is connected to carrier network node 242 and carrier switching center 240. T1 voice links 212 provide connection between the information/call center's switching matrix platform 203 and carrier's switching center 240, through which incoming information service calls are received. T1 voice links 212 further provide connection to the carrier switching center 240 through which outgoing calls are placed over communications network 246 (which network may be different than that used for incoming calls). Similarly, T1 data links 213 provide a signaling connection between the information/call center's node (not shown) and carrier network node 242, through which incoming and outgoing signaling messages are transported. The information/call center node is contained within switching matrix platform 203, but one with skill in the art will appreciate that the information/call center node could also be a physically distinct component. If the outgoing call is being placed over a different network than that on which the incoming call was received, a second data connection to the outgoing network will be established.

The operation of switching matrix platform 203 is governed by computer-readable instructions stored and executed on switch matrix host computer 228. In this illustrative embodiment, platform 203 includes, inter alia, arrays of digital signal processors (DSPs). These DSPs can be programmed and reprogrammed to function as, among other things, call progress analyzers (CPAs), call progress generators (CPGs), multi-frequency (MF) tone generators/detectors, dual-tone multi-frequency (DTMF) generators/detectors, or conference units, depending on the demand placed on center 200 and platform 203 for each corresponding function.

Voice server 230 is connected via data network 224 to computer 228 (to which it acts as a slave processor) and via one or more T1 links to switching matrix platform 203. Each voice server 230 when more than one is employed in information/call center 200, connects to switching matrix platform 203 via a separate T1 link. Voice server 230 comprises a general purpose computer incorporating one or more voice cards, which serve as the interface between server 230 and the T1 span to switching matrix platform 203. One such voice card in server 230 monitors and controls communications over the T1 span. Its capabilities include telephone tone (e.g., DTMF or MF) detection and generation, voice recording and playback, and call progress analysis. Voice server 230 in this instance also contains a voice recognition device for receiving verbal input from a party connected thereto. Voice server 230 is employed to play the constantly repeated parts of an operator's speech, including, for example, the caller's desired telephone number where requested, and possibly other information. At appropriate stages in a call progression, switch matrix host computer 228 initiates a voice path connection between voice server 30 and switching matrix platform 203 such that the user, or the user and the operator, are able to hear whatever pre-recorded speech is played on that connection by voice server 230. Computer 228 then instructs voice server 230, via data network 224, what type of message to play, and passes data parameters that enable voice server 230 to locate the message appropriate to the call state.

Users of a particular telephone carrier may dial, speak or otherwise communicate predetermined access digits, access codes or retail numbers, or input a predetermined address or a URL established for information assistance by that company. The instant example assumes that the user dials, e.g., “411,” “*555,” “555-1212,” “1-800-555-1212,” “00,” or other designated access numbers. The participating telephone company's own switching system will then reroute the call to information/call center 200 (via a T1 channel), where it appears as an incoming call.

Automatic call distribution (ACD) logic is used to queue (if necessary) and distribute calls to operators in the order in which they are received, and such that the call traffic is distributed evenly among the operators. In other embodiments, other distribution logic schemes may be utilized, such as skills-based routing based on, e.g., a preferred call handling method specified by a user profile, or a priority scheme for preferred callers. The queue is maintained by switching matrix host computer 228.

When the user uses telecommunication device 244, e.g., a wireless telephone, to call an operator at a designated access number for information assistance, the call is routed to, say, information/call center 200. After receiving the call, center 200 checks any user profile record associated with the user. In general, a user profile record is identified by a user's telephone number and maintained by a profile manager described below. Referring back to FIG. 2A, an information assistance call is received by switching matrix platform 203 in center 200. In a well known manner, platform 203 derives, from the call set-up signals associated with the call, an automatic number identification (ANI) indicating the telephone number of the communication device from which the call originates. Switching matrix host computer 228 then requests any user profile record identified by such an ANI from gateway 231 connected to data network 224.

Referring also to FIG. 3, gateway 231 receives the profile record request including the ANI from data network 224 through interface 310. In response to such a request, processor 315 searches memory 319 for the profile record identified by the ANI. It should be noted at this point that all profile data is input and updated through profile manager 305. Copies of the profile records are distributed by manager 305 to the profile gateways in various information/call centers through WAN 30. In this illustrative embodiment, a master copy of the profile records is kept at manager 305. For example, profile gateway 231 initially forwards requests for new profile records to manager 305, and caches copies of the requested profile records from manager 305 in local memory 319 for rapid, subsequent retrieval of the profile records. Memory 319 here generically includes disks, caches, and volatile and nonvolatile memories. When a particular profile record in gateway 231 is updated at manager 305, the latter notifies gateway 231 that the particular profile record has expired.

Thus, continuing the above example, if processor 315 determines that the requested profile record cannot be found in memory 319 or the requested profile record has expired, processor 315 forwards the profile record request to manager 305 through interface 310. In response, manager 305 provides to gateway 231 any latest profile record identified by the ANI. Otherwise, processor 315 retrieves from memory 319 any available, unexpired profile record identified by the ANI.

Upon learning either the “profileless” or “profile data deficient” status of the user, manager 305 causes voice server 230 to seize the instant information assistance call, and elicit from the user information about his/her preferences to establish the user profile record or to supplement the same. By way of example, an important aspect of the user profile is the user's preferred call handling style, which is missing in this instance.

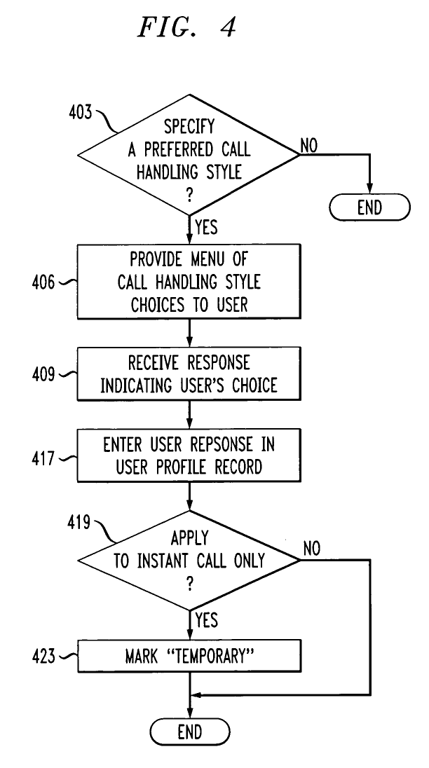

FIG. 4 illustrates a routine for eliciting from the user information concerning the user's preferred call handling style, before the instant call is handled by an operator. At step 403, voice server 230 asks the user whether he/she wishes to specify a preferred call handling style, e.g., “skier”, “businessperson” or “humor” to more personalize the call handling. If not, the routine comes to an end. Otherwise, server 230 at step 406 provides to user a menu of available choices of preferred call handling style. Server 230 receives a response from the user at step 409. In one implementation, the user may enter a response verbally. In this implementation, the user's response is recognized by the aforementioned voice recognition device in server 230. At step 417, the response is entered by manager 305 in the user profile record, which is newly established if no user profile record has been established for the user. Server at step 419 asks the user whether the preferred call handling style applies to the instant call only or to all calls, and becomes receptive to the user response. If such preference applies to the instant call only, the profile entry is marked “temporary,” as indicated at step 423, which is to be erased from the user profile record after the termination of the instant call. In that case, server 230 may again elicit from the user the preferred call handling style in a subsequent information assistance call by the user.

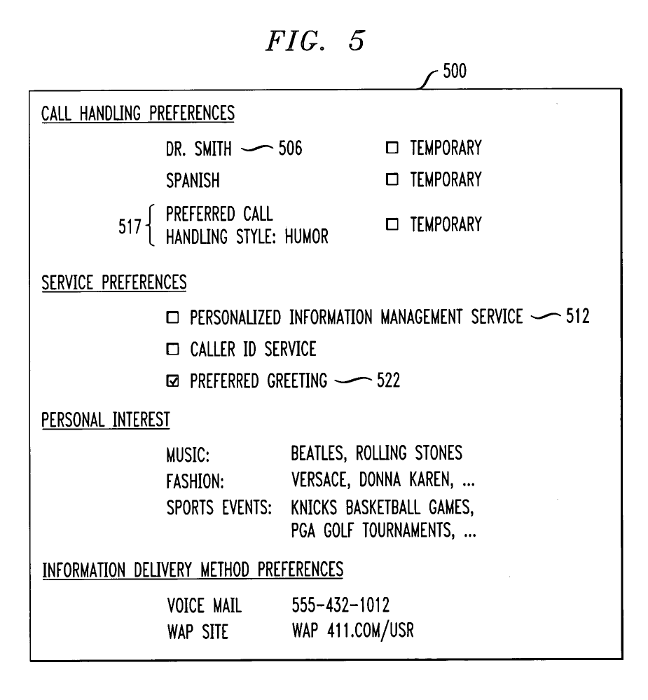

FIG. 5 illustrates a user profile record 500 associated with a hypothetical user named Dr. Smith. User profile record 500 contains information concerning the user's call handling preferences, such as, for example, the user's preferred name and title 506. User profile record 500 also contains user preferences including information concerning the user's subscription to enhanced services or features, e.g., personalized information management service option 512 for maintaining contacts, appointments and other folders that may be maintained for the user. Some examples of such enhanced services are described in the '230 application and in the '130 application. In addition, user profile record 500 indicates the user's preferred call handling style 517. In this instance, Dr. Smith's preferred call handling style is “humor.” User profile record 500 is updated from time to time when one or more user preferences are changed, and in particular each time when the user subscribes to a new enhanced service or cancels an enhanced service subscription.

In accordance with one aspect of the invention, a call is received from a user, data identifying the user is obtained, the user's profile is accessed based on the user identifying data, data indicating the user's preferred call handling style is obtained from the user profile, a personalized greeting is generated based on the user's preferred call handling style, and the greeting is delivered to the user.

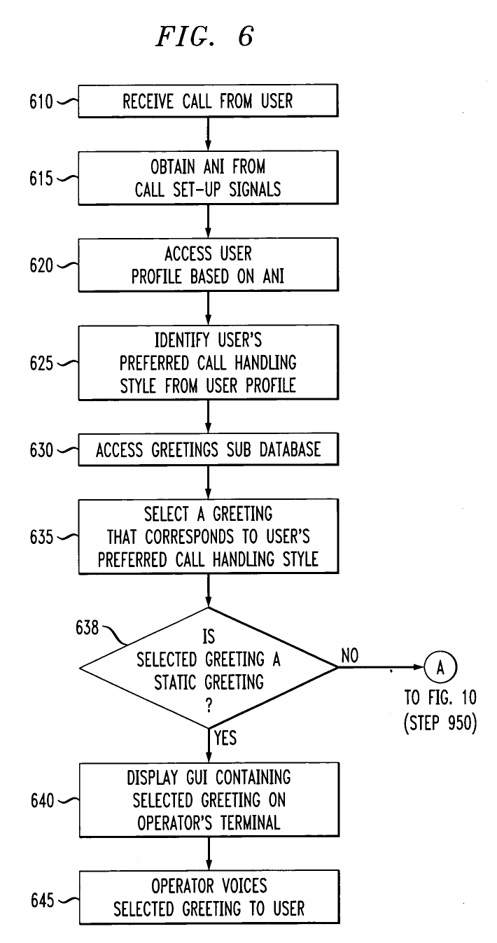

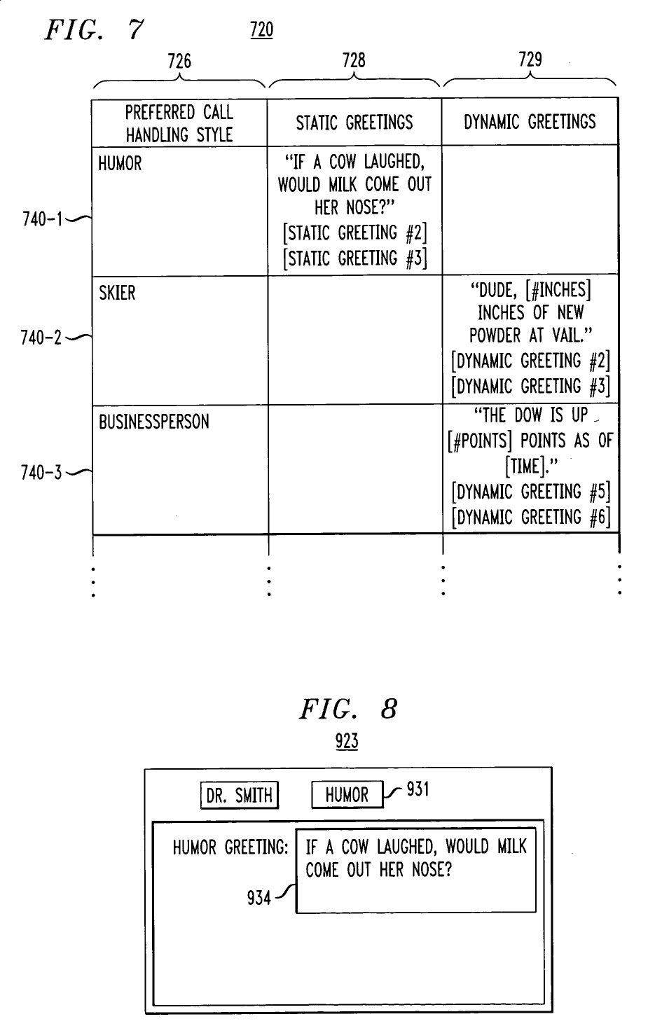

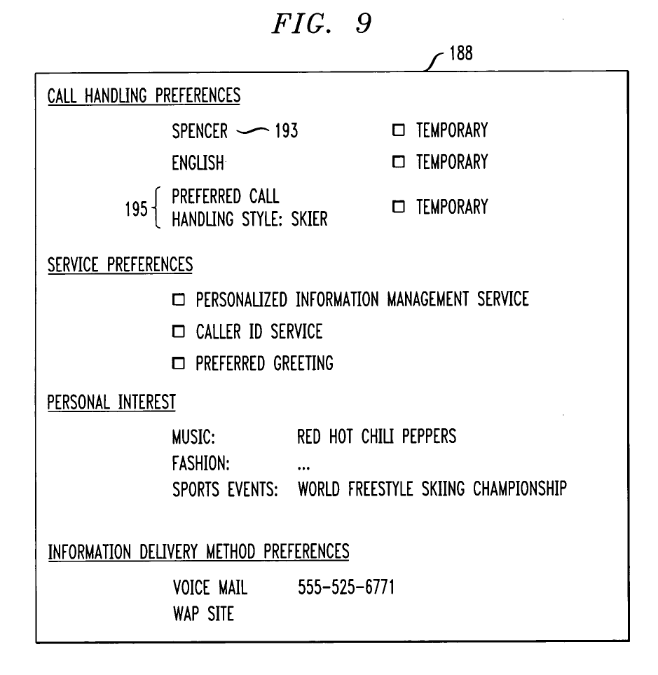

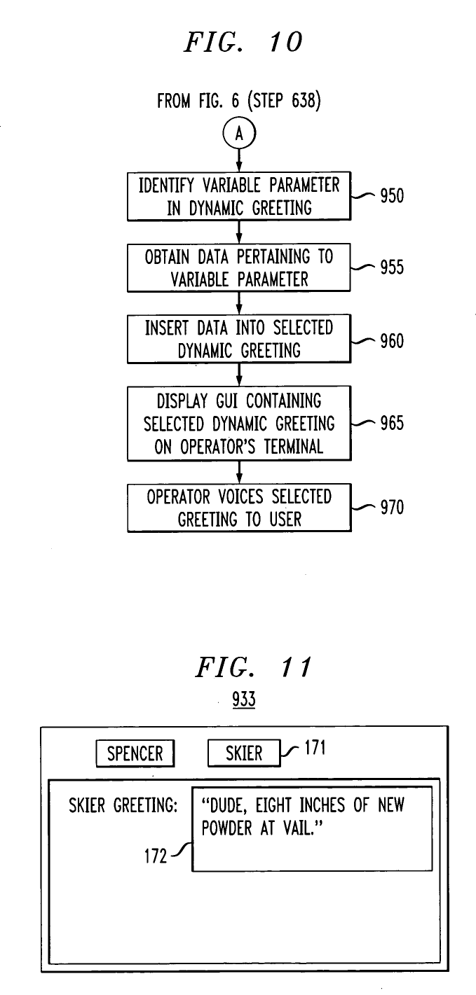

FIG. 6 is a flowchart depicting a method for generating and communicating a personalized greeting in accordance with this aspect of the invention. The method outlined in FIG. 6 is also discussed with reference to FIGS. 1 and 2. At step 610, an information assistance call is received from a user by information/call center 200. At step 615, switching matrix platform 203 receives an ANI from the call set-up signals associated with the call. In this particular illustrative embodiment, the user is identified at the information call center by the ANI; alternatively, the user may be identified by, or in combination with, a user identification (ID), password, PIN, mother's maiden name, user voice recognition, user voiceprint, etc. An example of a system for using a voiceprint for the purpose of identifying a user is provided in U.S. patent application Ser. No. 10/403,207, entitled “Communications Methods and Systems Using Voiceprints,” by T. Timmins et al., filed Mar. 31, 2003, which is hereby incorporated by reference in its entirety.

At step 620, information call/center 200 obtains access to a user profile based on the user's ANI. In the embodiment illustrated in FIGS. 1 and 2, switching matrix host computer 228 may request a user profile record identified by the user's ANI from user profile gateway 231 connected to data network 224. Gateway 231 communicates with server 28, which utilizes the user's ANI to retrieve the corresponding user profile from database 20. If, for example, an information assistance call is received from Dr. Smith, server 28 uses the ANI identifying the telephone number from which Dr. Smith's call originates to retrieve Dr. Smith's profile 500 from database 20.

At step 625, the user's preferred call handling style and personalized greeting preference are identified from the user's profile. In the embodiment shown in FIG. 1, server 28 may determine the user's preferred call handling style by examining the preferred call handling style field contained in the user profile. Referring to Dr. Smith's profile 500, for example, server 28 may read preferred call handling style field 517 and determine that Dr. Smith's preferred call handling style is “humor.”

At step 630, server 28 accesses a greetings file to select a personalized greeting for the user. In one implementation, server 28 maintains within database 20a greetings subdatabase such as that shown in FIG. 7. Referring to FIG. 7, greetings subdatabase 720 contains three columns 726, 728 and 729. Column 726 indicates a respective preferred call handling style, such as, for example, humor, skier, or businessperson. Column 728 stores, for a respective preferred call handling style indicated in column 726, one or more “static” greetings. For example, referring to row 740-1, the greetings, “IF A COW LAUGHED, WOULD MILK COME OUT HER NOSE?,” and similar greetings denoted [STATIC GREETING #2] and [STATIC GREETING #3] are associated with the humor call handling style. Column 729 stores, for a respective preferred call handling style, one or more “dynamic” greetings. For example, referring to row 740-2, the greetings, “Dude, [#INCHES] inches of new powder at Vail,” and similar greetings denoted [DYNAMIC GREETING #2],” and “[DYNAMIC GREETING #3]” are associated with the skier call handling style. Likewise (referring to row 740-3), “The Dow is up [#POINTS] points as of [TIME],” and similar greetings denoted [DYNAMIC GREETING #5],” and “[DYNAMIC GREETING #6]” are associated with the businessperson call handling style.

Each of the dynamic greetings stored in dynamic greetings subdatabase 720 contains at least one variable parameter representing an item of information that must be inserted to complete the greeting. For example, referring to row 740-2, the greeting “Dude, [#INCHES] inches of new powder at Vail” contains the variable parameter [#INCHES] representing, in this instance, how many inches of fresh snow have fallen at the Vail Ski Resort. Some dynamic greetings may have multiple variable parameters. For example (referring to row 740-3), the dynamic greeting “The Dow is up [#POINTS] points as of [TIME]” contains two variable parameters, [#POINTS], representing a change in the stock market average, and [TIME], representing a time of the day.

In accordance with this embodiment, a row associated with the user's preferred call handling style is identified. At this point during Mr. Smith's call, for example, server 28 may identify row 740-1, corresponding to the “humor” call handling style.

Returning to FIG. 6, at step 635, a greeting that corresponds to the user's preferred call handling style is selected. To generate a personalized greeting for Dr. Smith, for example, server 28 may select one of the greetings stored in row 740-1, say, “IF A COW LAUGHED, WOULD MILK COME OUT HER NOSE?.” In one embodiment, server 28 may select randomly from among the greetings that correspond to the user's preferred call handling style. In another embodiment, server 28 may “rotate” through the available greetings stored in the corresponding row, e.g., row 740-1. In this embodiment, server 28 may, for example, maintain a pointer or an indicator in a respective user's profile indicating the greeting that was most recently delivered to the user. When a subsequent call is received from the user, server 28 may accordingly identify a list of greetings associated with the user's preferred call handling style (e.g., those stored in row 740-1), check the memory location of the last greeting associated with the preferred call handling style indicated by the pointer, select the next greeting contained in the list at the next memory location which the pointer is updated to indicate, and deliver the greeting. If the pointer points to a greeting located at the end of the list, server 28 may return to the beginning of the list and select the first available greeting. Because in this case the greeting selected at step 635 is a static greeting from column 728, the subject call handling routine proceeds to step 640. Otherwise (referring to block 638), if the selected greeting is a dynamic greeting from column 729, the routine proceeds to step 950 in FIG. 10. As discussed above, a dynamic greeting incorporates information such as weather information, stock quotes, etc., which needs to be updated in real-time or near real-time when the greeting is delivered to the user.

At step 640, server 28 presents a graphical user interface (GUI) on the terminal 120 at which an assigned operator is currently attending to the user's information assistance call. FIG. 8 illustrates a GUI 923 that may be displayed on the terminal 120 for an operator attending to a user—in this instance, Dr. Smith. Referring to FIG. 8, Dr. Smith's preferred call handling style is indicated in field 931, and the selected personalized greeting is presented in field 934, in this instance, “IF A COW LAUGHED, WOULD MILK COME OUT HER NOSE?”

At step 645, the operator delivers the selected greeting to the user. In one implementation, a human operator may voice the greeting to the user. In an alternative implementation, the selected greeting may be delivered by automated voice using voice server 230.

In a second embodiment, a call is received from a user, say, Spencer, whose profile record 188 is illustrated in FIG. 9. As shown in FIG. 9, Spencer's preferred call handling style is “skier.” Spencer's call is handled in a manner similar to Dr. Smith's, with respect to steps 610-635 of FIG. 6. However, when server 28 accesses greetings subdatabase 720 in FIG. 7, the greeting is retrieved from dynamic greeting column 729. In this instance, at step 638, because of Spencer's skier call handling style, the selected greeting is one from among those dynamic greetings listed in row 740-2, e.g., “Dude, [#INCHES] inches of new powder at Vail.” As a result, the call handling routine proceeds to step 950 in FIG. 10.

At step 950, server 28 identifies one or more variable parameters within the selected dynamic greeting. In the example provided above, server 28 may determine that the dynamic greeting “Dude, [#INCHES] inches of new powder at Vail” contains the variable parameter [#INCHES].

At step 955, server 28 obtains data pertaining to the identified variable parameter(s). Server 28 may utilize the Internet or other proprietary or contracted sources to obtain various items of data such as, for example, stock quotes, interest rates, ski conditions, weather conditions, airline ticket prices, etc. In the case of Spencer's call, for example, server 28 may access an Internet website pertaining to ski conditions and determine that the Vail ski resort currently offers eight inches of new powder. In another implementation, server 28 may access a ski conditions database that stores various items of up-to-date information. Such ski conditions database may be maintained by the information assistance provider or by a third party.

At step 960, server 28 incorporates the data into the selected dynamic greeting. In the instant case, for example, server 28 combines the data obtained via the Internet with the selected dynamic greeting to generate the greeting “Dude, eight inches of new powder at Vail.”

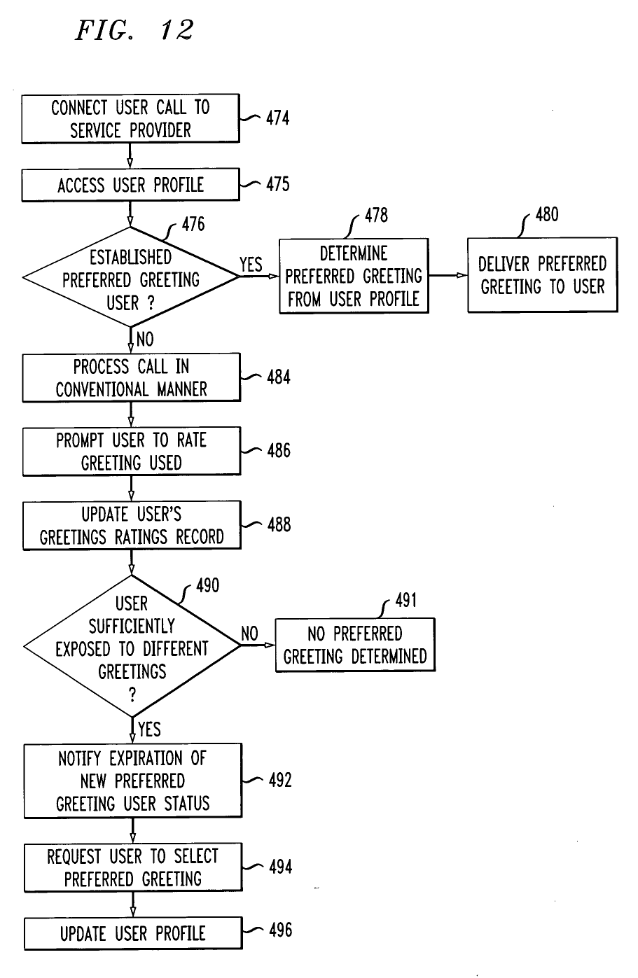

At step 965, server 28 presents a GUI on the terminal 120 at which an assigned operator is currently attending to the user's information assistance call. FIG. 11 illustrates a GUI 933 that may be displayed on the terminal 120 for an operator attending to a user—in this instance, Spencer. Referring to FIG. 11, Spencer's preferred call handling style is indicated in field 171, and a selected dynamic greeting is presented in field 172.

At step 970, the operator delivers the selected dynamic greeting to the user. In one implementation, a human operator may voice the dynamic greeting to the user. In an alternative implementation, the selected dynamic greeting may be delivered by automated voice using server 230.

In accordance with a further aspect of the invention, a user may be able to select one or more personalized greetings that he/she wishes to hear during an information assistance call. Of course, before a user can identify which greeting(s) he/she prefers, he/she must have some experience with one or more of the available greetings. When a user first signs on with the instant information assistance service, he/she will not know which greeting(s) he/she prefers. In this event, the user can simply use the service for some period of time without the preferred greeting feature, and can notify the instant service provider when he/she has identified one or more greetings he/she prefers.

In an embodiment of the invention, at the end of each interaction the user has with an information/call center (e.g., after the operator disconnects from the call but before the caller is either transferred to the destination party or the system disconnects from the call), voice server 230 is programed to ask the user to rate the greeting that was delivered during the call on a scale from 0 to 9, 9 being the best. The user makes his/her selection by pressing the corresponding key on his telephone keypad, and the system records the greeting ratings. After the user has been sufficiently exposed to many greetings, the service provider can inform the subscriber how he/she has ranked the different greetings, and, based on this information, the user can then select which greeting he/she would like in his/her preferred pool. Of course, the user is free to add or delete a greeting from his/her preferred pool at any time, or can decide anytime which greeting(s) he/she would like in his/her preferred pool.

This aspect of the instant invention has the additional advantage of allowing the ratings given by different users to each greeting to be accumulated, saved and used by the provider of the instant service for purposes of evaluating the popularity of its greetings. The subscriber first advises the service provider that he/she wishes to begin using the preferred greeting feature. The user can advise the service provider of this fact in a number of ways, including a standard call for service to the service provider, a call to the service provider via a special telephone number provided by the service provider for account status/update calls and the like, or by mail, e-mail, fax, pager or other communications media, all of which are within the scope of the instant invention. The user profile is then updated to indicate that he/she is a new preferred greeting user.

Thereafter, in accordance with one embodiment, the user's greetings preferences may be recorded in accordance with the routine depicted in FIG. 12. At step 474, the user is connected to the service provider for information assistance service. At step 475, the user's profile is accessed in the manner described above. In one embodiment, computer 228 identifies the user by the ANI obtained from the call set-up signals associated with his/her telephone call.

At step 476, computer 228 checks the user profile record to determine if the user is an established preferred greeting user, i.e., a user whose preferred greeting has already been determined. If the user is not an established user, meaning a user who has expressed the desire to use the preferred greeting feature but has not yet had his/her preferred greeting identified, the information/call center processes the call in the manner described previously (step 484). Accordingly, a greeting is generated and delivered to the user based on his/her preferred call handling style, and any requested information assistance service is provided to the user. At the end of the call, at step 486, the user is prompted to enter his/her rating of the greeting used during the call. At step 488, the user's greeting ratings record is then updated.

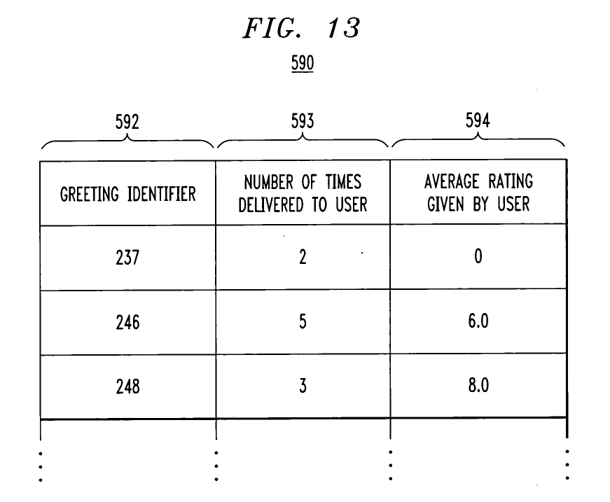

Data concerning a user's ratings for various greetings may be stored in the form of a table, such as table 590 shown in FIG. 13. Column 592 of table 590 contains identifiers (e.g., alphanumerical) identifying various greetings that are available for delivery to a user (e.g., greetings that are stored in greetings file 720). For example, the identifier 237 may be associated with the greeting “IF A COW LAUGHED, WOULD MILK COME OUT HER NOSE?” Column 593 of table 590 indicates the number of times the greeting has been delivered to the user since the user has been a new preferred greetings user. Column 594 contains an average of the ratings that the user has given to each greeting. Table 590 may be stored within the user's profile, although those skilled in the art having the benefit of the instant disclosure will appreciate that there are a number of ways this information can be stored to achieve the advantages of the instant invention, each of which is within the scope of the instant invention.

In the example illustrated by table 590, because the user rated greeting 237 a “0” on two previous interactions, computer 228 (or the user) may decide that such greeting should not be delivered to the respective user during any future calls, even though the user is still a new preferred greeting user and has not yet selected his/her preferred greeting.

Returning to FIG. 12, as indicated by block 490, computer 228 determines whether the user has been sufficiently exposed to various greetings. In one embodiment, the determination as to whether a user has been sufficiently exposed to various greetings may be made based on an algorithm present within computer 228, e.g., a user has been sufficiently exposed if he/she has heard, say, ten greetings. If computer 228 determines that the user has not been sufficiently exposed to different greetings, then according to step 491 no preferred greeting is determined, until perhaps the next time the user calls for service.

If the user has been sufficiently exposed to different greetings, the user is notified at step 492 of the expiration of his/her new preferred greeting user status, as well as of the rankings that the user has given to the different greeting he/she has heard. At step 494, the user is requested to select his/her preferred greeting. This interaction between the service provider and the user can occur via any of the communications methods described above. Finally, at step 496, computer 228 updates the user profile to indicate that the user is now a preferred greeting user, along with the identity of the user's preferred greeting.

Referring briefly to FIG. 5, Dr. Smith's user profile record 500 contains user preferences including information concerning the user's subscription to enhanced services or features, e.g., preferred greetings feature option 522. Record 500 is updated from time to time when one or more user preferences are changed, and in particular each time when the user subscribes to a new enhanced service or cancels an enhanced service subscription.

Returning to FIG. 12, if at block 476, the user is an established preferred greetings user, computer 228 in step 478 consults the user profile record to determine which greeting has been marked as the user's preferred greeting. At step 480, the preferred greeting is delivered to the user.

In an alternative implementation, a user may indicate multiple preferred greetings. In accordance with this implementation, computer 228 may, for example, select randomly from among the user's preferred greetings.

The foregoing merely illustrates the principles of the invention. It will thus be appreciated that those skilled in the art will be able to devise numerous other arrangements that embody the principles of the invention and are thus within the spirit and scope of the invention, which is defined by the claims below.

For example, information/call center 200 and its components are disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

1. A method for handling a call from a user, comprising:
obtaining information identifying the user;
obtaining, based on the information, a record containing data concerning a call handling style preferred by the user;
generating, based on the call handling style, a message for greeting the user; and
delivering the message to the user during the call.

2. The method of claim 1, wherein the information includes an automatic number identifier (ANI) associated with call.

3. The method of claim 1, wherein the information includes a voiceprint.

4. The method of claim 1, wherein the information includes a PIN.

5. The method of claim 1, wherein the information includes a password.

6. The method of claim 1, wherein the message comprises one or more variable parameters whose representations are determined when the call is received.

7. The method of claim 6, wherein the variable parameters are time-sensitive.

8. The method of claim 1, wherein the call handling style includes humor.

9. The method of claim 1, wherein the call handling style relates to a lifestyle.

10. The method of claim 9, wherein the lifestyle relates to a businessperson lifestyle.

11. The method of claim 9, wherein the lifestyle relates to a skier lifestyle.

12. A method for greeting a caller, comprising:
receiving a call from the caller;
obtaining data concerning a call handling style preferred by the user;
selecting, based on the data, a message for greeting the user, the message including at least one variable parameter;
determining information represented by the variable parameter;
inserting the information in place of the variable parameter in the message; and
providing the resulting message to the user during the call.

13. The method of claim 12, wherein the variable parameter is time-sensitive.

14. The method of claim 12, wherein the call handling style includes humor.

15. The method of claim 12, wherein the call handling style relates to a lifestyle.

16. The method of claim 15, wherein the lifestyle relates to a businessperson lifestyle.

17. The method of claim 15, wherein the lifestyle relates to a skier lifestyle.

18. A system for handling a call from a user, comprising:
an interface for obtaining information identifying the user;
a device for obtaining, based on the information, a record containing data concerning a call handling style preferred by the user; and
a server for generating, based on the call handling style, a message for greeting the user, the message being delivered to the user during the call.

19. The system of claim 18, wherein the information includes an ANI associated with call.

20. The system of claim 18, wherein the information includes a voiceprint.

21. The system of claim 18, wherein the information includes a PIN.

22. The system of claim 18, wherein the information includes a password.

23. The system of claim 18, wherein the message comprises one or more variable parameters whose representations are determined when the call is received.

24. The system of claim 23, wherein the variable parameters are time-sensitive.

25. The system of claim 18, wherein the call handling style includes humor.

26. The system of claim 18, wherein the call handling style relates to a lifestyle.

27. The system of claim 26, wherein the lifestyle relates to a businessperson lifestyle.

28. The system of claim 26, wherein the lifestyle relates to a skier lifestyle.

29. A system for greeting a caller, comprising:
an interface for receiving a call from the caller;
a device for obtaining data concerning a call handling style preferred by the user;
a server for selecting, based on the data, a message for greeting the user, the message including at least one variable parameter; and
a mechanism for determining information represented by the variable parameter, the information being inserted in the message in place of the variable parameter, the resulting message being provided to the user during the call.

30. The system of claim 29, wherein the variable parameter is time-sensitive.

31. The system of claim 29, wherein the call handling style includes humor.

32. The system of claim 29, wherein the call handling style relates to a lifestyle.

33. The system of claim 32, wherein the lifestyle relates to a businessperson lifestyle.

34. The system of claim 32, wherein the lifestyle relates to a skier lifestyle.
